(19) United States
(12) Patent Application Publication
(10) Pub. No.: US 2015/0282478 A1
(43) Pub. Date: Oct. 8, 2015

(54) Drift Reducing Compositions

(71) Applicant: CLARIANT INTERNATIONAL LTD, Muttenz (CH)

(72) Inventors: Peter Baur, Schondorf (DE); Robert Milbradt, Wiesbaden (DE); Peter Mansour, Wiesbaden (DE)

(73) Assignee: Clariant Finance (BVI) Limited, Tortola (VG)

(21) Appl. No.: 14/438,192

(22) PCT Filed: Oct. 23, 2013
(86) PCT No.: PCT/EP2013/003196

§ 371 Date: Apr. 23, 2015

(30) Foreign Application Priority Data
Oct. 24, 2012 (DE) 12 189 831.6

(51) Int. Cl. A01N 25/30; A01N 25/02

(52) U.S. Cl. CPC A01N 25/30; A01N 25/02

(57) ABSTRACT

The invention relates to one or several copolymers A), wherein the copolymers contain one or several structural units, derived from a) 19.9 to 75.9 weight percent glycerin; b) 0.1 to 30 weight percent of at least one dicarboxylic acid, and c) 24 to 80 weight percent of at least one monocarboxylic acid of formula (I)

R¹—COOH (I),

wherein R¹ is (C₅-C₂₉)-alkyl; (C₇-C₂₉)-alkenyl; phenyl, or naphthyl, and compositions containing one or several copolymers A) and B) a water-immiscible fluid medium, containing one or several members of the group consisting of esters of monocarboxylic and dicarboxylic acids, the acid and/or alcohol component of which has at least 4 C-atoms, plant-based oils, mineral oils, and aromatic hydrocarbons are suitable for reducing the drift during the application of pesticide preparations.

The invention relates to the use of particular copolymers, especially as compositions with a water-immiscible liquid medium, as drift-reducing components in pesticide formulations, to a method of reducing drift in the application of pesticide formulations, and to compositions for reducing drift.

Crop protection compositions are applied to agricultural production fields in a very efficient manner using spray tanks in aircraft, tractors or other equipment. In order to achieve very exact positioning of the active substances, it is necessary to obtain a very narrow spray cone and to prevent drift of the spray mist away from the target site.

The drift of the spray cone is determined essentially by the droplet size. The smaller the droplets, the longer their residence time in the air and the greater their tendency to evaporate and/or to drift away horizontally and to miss the target site.

Distinct minimization of the drift effect can be achieved by addition to pesticide formulations of suitable “drift control agents” which bring about an increase in the droplet size in the spray mist. The formulations which have been modified with drift control agents additionally have to be insensitive to the shear forces to which they are subjected in the spray pumps and nozzles. Good biodegradability, compatibility with other constituents of the crop protection compositions and a high storage stability and thermal stability are further demands on drift control agents. It is known that the rheology of aqueous compositions can be modified by addition of water-soluble polymers, for example polyacrylamides, acrylamide/acrylic acid polymers, sodium polyacrylate, carboxymethyl cellulose, hydroxyethyl cellulose, methyl cellulose, polysaccharides, natural and synthetic guar gum (U.S. Pat. No. 4,413,087, U.S. Pat. No. 4,505,827, U.S. Pat. No. 5,874,096).

Polymers of acrylamido-2-methylpropanesulfonic acid and acrylamide and the use thereof as drift-reducing adjuvants are known from WO 2001/060877.

Even though good results are already achieved with the known systems, there is still a need, for technical, economic and ecological reasons, to find suitable drift control agents which, even under practical conditions, effectively increase the droplet volumes of the aqueous compositions and reduce drift of the spray cone.

It has been found that, surprisingly, particular polyglycerol-based copolymers, especially in compositions with water-immiscible oils, are suitable as drift-reducing adjuvants for crop protection compositions and bring about an increase in particle size and a reduction in the spray cone when these crop protection compositions are sprayed. The compositions of this kind are already known in general terms from WO 2012/119722 as additives to crop protection compositions. However, no pointer to possible suitability for drift reduction can be found in the document.

The invention therefore provides for the use of one or more copolymers A) containing one or more structural units deriving from
a) 19.9% to 75.9% by weight of glycerol
b) 0.1% to 30% by weight of at least one dicarboxylic acid and
c) 24% to 80% by weight of at least one monocarboxylic acid of the formula (I)

R¹—COOH (I)

where R¹ is (C₅-C₂₉)-alkyl; (C₇-C₂₉)-alkenyl; phenyl or naphthyl,
for reducing drift in the application of pesticide formulations.

The invention further provides for the use of compositions comprising

A) one or more copolymers, where the copolymers contain one or more structural units deriving from
a) 19.9% to 75.9% by weight of glycerol
b) 0.1% to 30% by weight of at least one dicarboxylic acid and
c) 24% to 80% by weight of at least one monocarboxylic acid of the formula (I)

R¹—COOH (I)

where R¹ is (C₅-C₂₉)-alkyl; (C₇-C₂₉)-alkenyl; phenyl or naphthyl
and
B) a water-immiscible liquid medium comprising one or more representatives from the group consisting of esters of mono- and dicarboxylic acids, the acid and/or alcohol component of the latter having at least 4 carbon atoms, vegetable oils, mineral oils and aromatic hydrocarbons,
for reducing drift in the application of pesticide formulations.

“Drift” in the context of the invention is understood to mean the effect that the spraying of the crop protection composition forms small droplets which can be carried beyond the area to be treated, and can thus make the spraying less effective or even harmful to adjacent areas and crops.

According to the invention, drift reduction is preferably understood to mean the reduction in the proportion of small droplets compared to the application of a composition which does not contain the composition of the invention, preferably by at least 10% (based on the droplets having a diameter smaller than the mean diameter in the composition minus the composition of the invention).

Application in the context of the invention is understood to mean the application of an aqueous spray liquor comprising one or more active ingredients, the copolymers or compositions used in accordance with the invention, and optionally further auxiliaries and/or additives.

Preferably, the compositions used in accordance with the invention contain either zero water or water in an amount of less than or equal to 1.0% by weight, based in each case on the total weight of the respective composition.

In the copolymer component A), the proportions of monomers a), b) and c) specified (in % by weight) are based on the total amount of the monomers as used for preparation of the copolymers. They do not relate to the final composition of the copolymers, which differs slightly therefrom as a result of elimination of water released in the course of condensation. As disclosed in WO 2012/119722, the proportion of the dicarboxylic acid has no effect on the dispersibility of the copolymers according to component A) of the compositions of the invention in the dispersing medium; instead, it is determined merely by the proportion of the monocarboxylic acid.

The compositions of the copolymers that are possible in principle, and also the preparation and embodiments of the copolymerization, are described in EP 1 379 129. A common factor in all cases is that the condensation reactions proceed between alcohols and/or carboxylic acids, meaning that the monomers are joined to one another by ether bonds (in the case of condensation of two alcohol functions of the glycerol) or by ester bonds (in the case of condensation of one alcohol function of the glycerol with one carboxylic acid function of the mono- or dicarboxylic acid).

The copolymers A) are preferably prepared in such a way that monoglycerol is first condensed to give an oligo- or polyglycerol and only then reacted with the at least one dicarboxylic acid b) and the at least one monocarboxylic acid c). The effect of this is that the copolymers A), in this preferred embodiment of the invention, contain condensed oligo- or polyglycerol units.

The at least one dicarboxylic acid b) is preferably oxalic acid, a dicarboxylic acid of the formula (II)

HOOC—R²—COOH (II)

and/or a dicarboxylic acid of the formula (III)

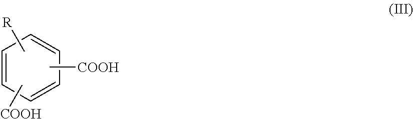

where R² is a (C₁-C₄₀)-alkylene bridge or a (C₂-C₂₀)-alkenylene bridge and R is H, (C₁—C₂₀)-alkyl, (C₂-C₂₀)-alkenyl, phenyl, benzyl, halogen, —NO₂, (C₁-C₆)-alkoxy, —CHO or —CO((C₁-C₆)-alkyl).

More preferably, the at least one dicarboxylic acid b) is phthalic acid, and the at least one monocarboxylic acid c) is a coconut fatty acid.

In a very particularly preferred embodiment, the copolymers A) are based on

34.0% to 62.0% by weight of glycerol,
0.2% to 21.0% by weight of phthalic acid and
24.0% to 54.0% of coconut fatty acid.

The mean condensation level of the glycerol is preferably between 4.5 and 10.

Especially preferred are the copolymers 1 to 7 detailed in the examples section.

Preferably, the one or more copolymers A) consist of components a), b) and c).

The majority of the raw materials which are required for the preparation of the copolymers originate from renewable raw material sources. Glycerol nowadays is a by-product of biodiesel production; the monocarboxylic acids are obtained from animal or vegetable fats or oils; only the dicarboxylic acid is typically of synthetic origin.

As already mentioned, the “anhydrous” or “non-hydrous” compositions used with preference are preferably understood in the context of the invention to mean compositions which contain either zero water or water in an amount less than or equal to 1.0% by weight, based on the total weight of the respective composition. More preferably, the compositions used in accordance with the invention contain less than 0.5% by weight of water, based on the total weight of the respective composition. These water contents typically result from residual amounts of water formed as a by-product in the condensation of the copolymers, are already present in the solvents used, or are introduced additionally as an impurity during the process in the course of production of the compositions.

The water-immiscible components of the liquid medium B) are organic liquids having a solubility at room temperature (25° C.) of not more than 5% by weight and preferably of not more than 1% by weight in water. The components are selected from the group consisting of esters by mono- and/or dicarboxylic acids wherein the acid component and/or alcohol component contains at least 4 carbon atoms, vegetable oils, mineral oils and aromatic hydrocarbons.

Preference is given to esters of mono- and/or dicarboxylic acids each having at least 4 carbon atoms in the acid component and/or alcohol component and aromatic hydrocarbons.

Preferred esters of monocarboxylic acids and/or dicarboxylic acids each having at least 4 carbon atoms in the acid component and/or alcohol component are fatty acid alkyl esters, especially having 6 to 18 carbon atoms in the acid component and 1 to 8 carbon atoms in the alcohol component. Particular preference is given to rapeseed oil methyl ester, i.e. a transesterification product of rapeseed oil and methanol consisting of a mixture of methyl esters of saturated and unsaturated fatty acids each having 16 to 22 and especially 16 to 18 carbon atoms.

Further preferred esters are lactic esters having 4 or more carbon atoms in the alcohol moiety, particular preference being given to 2-ethylhexyl lactate.

Preferred aromatic hydrocarbons are, for example, solvent naphtha, toluene, xylene and especially C₆-C₁₆ aromatics mixtures, for example the Solvesso series comprising the following grades: Solvesso 100 (b.p. 162 to 177° C.), Solvesso 150 (b.p. 187 to 207° C.) and Solvesso 200 (b.p. 219 to 282° C.)

Preference is given, for example, to combinations of components A) and B) in which A) is a copolymer of glycerol, phthalic acid and coconut fatty acid, especially as described above, and B) is rapeseed oil methyl ester.

The proportion of the one or more copolymers of component A) in the compositions of the invention is preferably 1% to 90% by weight, more preferably 10% to 80% by weight and especially preferably 20% to 70% by weight, and the proportion of the one or more water-immiscible solvents of component B) is preferably 10% to 99% by weight, more preferably 20% to 90% by weight and especially preferably 30% to 80% by weight. These stated amounts are based on the total weight of the compositions of the invention.

As well as copolymer(s) and liquid medium, the compositions of the invention, or formulations which contain one or more copolymers A) minus the liquid medium, may include further additives which may assume various functions. Examples of auxiliaries by function are additional solvents, emulsifiers, adjuvants, wetting agents, penetrants, cold stabilizers, colorants, defoamers, antioxidants, frost protectants.

The compositions used in accordance with the invention or the copolymers A) are preferably used as a tankmix additive or tankmix adjuvant. “Tankmix” means that the copolymers or the composition of the invention is added to the aqueous spray liquor of a pesticide formulation. A tankmix adjuvant is a corresponding auxiliary which does not contain any pesticide but is processed together with one or more pesticides and optionally further additives, for example fertilizers, prior to application of the pesticide to give a spray liquor, and leads to an increase in the biological activity of the pesticide. An overview of the most commonly used types of tankmix adjuvants can be found in the

“Compendium of Herbicide Adjuvants” by Bryan G. Young, 10th edition, 2010.

Because of the surface-active properties of the copolymers, provided that they are present in a sufficient proportion, they are able to emulsify the solvent in an aqueous spray liquor and hence to achieve a homogeneous mixture.

Such compositions are also called adjuvant compositions used in accordance with the invention hereinafter.

In a further embodiment, the copolymers A) used in accordance with the invention or the compositions of the invention, when used as a tankmix adjuvant, additionally comprise one or more surface-active substances.

In a preferred embodiment of the invention, the copolymers A) used in accordance with the invention or compositions therefore additionally comprise one or more surface-active substances.

The surface-active substances help to convert the adjuvant compositions used in accordance with the invention, on dilution with water, to an emulsion in which the copolymer and optionally the solvent (liquid medium) are in homogeneous distribution.

Particularly suitable surface-active substances are ethoxylates or alkoxylates of long-chain (C₈ to C₂₄) linear or branched alcohols, EO/PO block copolymers (EO: ethyleneoxy unit; PO: propyleneoxy unit), alkylphenol ethoxylates and alkoxylates or tristyrylphenol ethoxylates and alkoxylates, tri-sec-butylphenol ethoxylates, castor oil ethoxylates, esters of long-chain carboxylic acids with mono- or polyhydric alcohols and the ethoxylation products thereof, salts of dodecylbenzenesulfonic acid, sulfosuccinates, phosphoric esters of ethoxylated fatty alcohols, tristyrylphenols and tri-sec-butylphenols and salts thereof.

Such an adjuvant composition used in accordance with the invention can also be referred to as a “crop oil concentrate”. A crop oil concentrate (COC) is a special form of a tankmix adjuvant, typically consisting of a mineral oil or vegetable oil and/or a fatty acid methyl or ethyl ester, and one or more emulsifiers or wetting agents. Other commonly used names for crop oil concentrates are crop oil, high surfactant oil concentrate or vegetable oil concentrate, or methylated or ethylated vegetable oil.

In the adjuvant compositions used in accordance with the invention (or formulations minus the liquid medium B)), the proportion of the one or more copolymers of component A) is preferably 1% to 90% by weight, more preferably 2% to 60% by weight and especially preferably 5% to 50% by weight. These stated amounts are based on the total weight of the adjuvant compositions of the invention.

In the adjuvant compositions used in accordance with the invention (or formulations minus the liquid medium B)) comprising one or more surface-active substances, the proportion of the one or more surface-active substances is preferably 0.1% to 50% by weight, more preferably 1% to 30% by weight and especially preferably 2% to 20% by weight. These stated amounts are based on the total weight of the adjuvant compositions used in accordance with the invention.

In said adjuvant compositions used in accordance with the invention which comprise a liquid medium B), the proportion of the liquid medium B) is preferably 1% to 98.9% by weight, more preferably 20% to 80% by weight and especially preferably 48% to 90% by weight. These stated amounts are based on the total weight of the adjuvant compositions used in accordance with the invention.

The copolymers A) or compositions used in accordance with the invention may likewise be used in the production of anhydrous pesticide formulations. This results in compositions used in accordance with the invention which comprise one or more pesticides.

In a preferred embodiment of the invention, the compositions or formulations used in accordance with the invention which comprise one or more copolymers A but no liquid medium B) therefore additionally comprise one or more pesticides. Compositions of this kind are also referred to hereinafter as “pesticide compositions used in accordance with the invention”.

Preferred pesticide compositions used in accordance with the invention are emulsion concentrates (ECs) and oil dispersions (ODs).

In an emulsion concentrate, the one or more pesticides are present in dissolved form in a solvent. In an oil dispersion, the one or more pesticides are present in dispersed form in a solvent (the oil). The “oil” may also not be an oil in the conventional sense (like a mineral oil or vegetable oil). Instead, this is understood to mean any water-immiscible solvent.

“Pesticides” are understood in the context of the present invention to mean herbicides, fungicides, insecticides, acaricides, bactericides, molluscicides, nematicides and rodenticides, and also phytohormones such as plant growth regulators. Phytohormones control physiological reactions such as growth, flowering rhythm, cell division and seed maturation. An overview of the most relevant pesticides can be found, for example, in “The Pesticide Manual” from the British Crop Protection Council, 16th Edition 2012, editor: C. MacBean. Explicit reference is hereby made to the active ingredients listed therein. They are incorporated into this description by citation.

The pesticides in the compositions of the invention are preferably selected from the group consisting of herbicides, insecticides, fungicides and plant growth regulators. Particular preference is given to herbicides.

Preferred fungicides are aliphatic nitrogen fungicides, amide fungicides such as acyl amino acid fungicides or anilide fungicides or benzamide fungicides or strobilurin fungicides, aromatic fungicides, benzimidazole fungicides, benzothiazole fungicides, carbamate fungicides, conazole fungicides such as imidazoles or triazoles, dicarboximide fungicides, dithiocarbamate fungicides, imidazole fungicides, morpholine fungicides, oxazole fungicides, pyrazole fungicides, pyridine fungicides, pyrimidine fungicides, pyrrole fungicides, quinone fungicides.

Preferred insecticides are carbamate insecticides such as benzofuranylmethyl carbamate insecticides or dimethyl carbamate insecticides or oxime carbamate insecticides or phenyl methylcarbamate insecticides, diamide insecticides, insect growth regulators, macrocyclic lactone insecticides such as avermectin insecticides or milbemycin insecticides or spinosyn insecticides, nereistoxin analog insecticides, nicotinoid insecticides such as nitroguanidine nicotinoid insecticides or pyridylmethylamine nicotinoid insecticides, organophosphorus insecticides such as organophosphate insecticides or organothiophosphate insecticides or phosphonate insecticides or phosphoramidothioate insecticides, oxadiazine insecticides, pyrazole insecticides, pyrethroid insecticides such as pyrethroid ester insecticides or pyrethroid ether insecticides or pyrethroid oxime insecticides, tetramic acid insecticides, tetrahydrofurandione insecticides, thiazole insecticides.

Preferred herbicides are amide herbicides, anilide herbicides, aromatic acid herbicides such as benzoic acid herbicides or picolinic acid herbicides, benzoylcyclohexanedione herbicides, benzofuranyl alkylsulfonate herbicides, benzothiazole herbicides, carbamate herbicides, carbanilate herbicides, cyclohexene oxime herbicides, cyclopropylisooxazole herbicides, dicarboximide herbicides, dinitroaniline herbicides, dinitrophenol herbicides, diphenyl ether herbicides, dithiocarbamate herbicides, glycine derivative herbicides, imidazolinone herbicides, isoxazole herbicides, isoxazolidinone herbicides, nitrile herbicides, organophosphorus herbicides, oxadiazolone herbicides, oxazole herbicides, phenoxy herbicides such as phenoxyacetic acid herbicides or phenoxybutanoic acid herbicides or phenoxypropionic acid herbicides or aryloxyphenoxypropionic acid herbicides, phenylpyrazoline herbicides, pyrazole herbicides such as benzoylpyrazole herbicides or phenylpyrazole herbicides, pyridazinone herbicides, pyridine herbicides, pyrimidinedione herbicides, thiocarbamate herbicides, triazine herbicides, triazinone herbicides, triazole herbicides, triazolone herbicides, triazolopyrimidine herbicides, triketone herbicides, uracil herbicides, urea herbicides such as phenylurea herbicides or sulfonylurea herbicides.

Examples of fungicides include:

(1) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoro-methyl)-4-[3-(trimethylsilyl)propoxy]phenyl}imidoform-amide and O-[1-(4-methoxyphenoxy)-3,3-dimethylbutan-2-yl]1H-imidazole-1-carbothioate.
(2) Respiration inhibitors (respiratory chain inhibitors), for example bixafen, boscalid, carboxin, diflumetorim, fenfuram, fluopyram, flutolanil, fluxapyroxad, furametpyr, furmecyclox, isopyrazam mixture of the syn-epimeric racemate 1RS,4SR,9RS and of the anti-epimeric racemate 1RS,4SR,9SR, isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxyl)phenyl]-3-(trifluoromethyl)-1H-pyrazole-4-carboxamide, 3-(difluoromethyl)-1-methyl-N-[2-(1,1,2,2-tetrafluoroethoxyl)phenyl]-1H-pyrazole-4-carboxamide, 3-(difluoromethyl)-N-[4-fluoro-2-(1,1,2,3,3,3-hexafluoropropoxyl)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]-quinazoline-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.
(3) Respiration inhibitors (respiratory chain inhibitors) acting on complex III of the respiratory chain, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methyl-phenoxy)-5-fluoropyrimidin-4-yl]oxy}phenyl)-2-(methoxy-imino)-N-methylethanamide, (2E)-2-(methoxyimino)-N-methyl-2-(2-{[({(1E)-1-[3-(trifluoromethyl)phenyl]-ethylidene}amino)oxy]methyl}phenyl)ethanamide, (2E)-2-(methoxyimino)-N-methyl-2-{2-[(E)-({1-[3-(trifluoro-methyl)phenyl]ethoxy}imino)methyl]phenyl}ethanamide, (2E)-2-{2-[({[(1E)-1-(3-{[(E)-1-fluoro-2-phenyl-ethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]-amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}-amino)oxy]methyl}phenyl)-2,4-dihydro-3H-1,2,4-triazol-3-one, methyl (2E)-2-{2-[({cyclopropyl[(4-methoxy-phenyl)imino]methyl}sulfanyl)methyl]phenyl}-3-methoxy-prop-2-enoate, N-(3-ethyl-3,5,5-trimethylcyclohexyl)-3-(formylamino)-2-hydroxybenzamide, 2-{2-[(2,5-dimethyl-phenoxy)methyl]phenyl}-2-methoxy-N-methylacetamide and (2R)-2-{2-[(2,5-dimethylphenoxy)methyl]phenyl}-2-methoxy-N-methylacetamide.
(4) Mitosis and cell division inhibitors, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.
(5) Compounds with multisite activity, for example Bordeaux mixture, captafol, captan, chlorothalonil, copper preparations such as copper hydroxide, copper naphthenate, copper oxide, copper oxychloride, copper sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulfur and sulfur preparations, for example calcium polysulfide, thiram, tolylfluanid, zineb and ziram.
(6) Resistance inductors, for example acibenzolar-S-methyl, isotianil, probenazole and tiadinil.
(7) Amino acid and protein biosynthesis inhibitors, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.
(8) Inhibitors of ATP production, for example fentin acetate, fentin chloride, fentin hydroxide and silthiofam.
(9) Cell wall synthesis inhibitors, for example benthiavalicarb, dimethomorph, flumorph, iprovalicarb, mandipropamid, polyoxins, polyoxorim, validamycin A and valifenalate.
(10) Lipid and membrane synthesis inhibitors, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.
(11) Melanin biosynthesis inhibitors, for example carpropamid, diclocymet, fenoxanil, fthalide, pyroquilon, tricyclazole and 2,2,2-trifluoroethyl {3-methyl-1-[(4-methylbenzoyl)amino]butan-2-yl}carbamate.
(12) Nucleic acid synthesis inhibitors, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.
(13) Signal transduction inhibitors, for example chlozolinate, fenpiclonil, fludioxonil, iprodione, procymidone, quinoxyfen and vinclozolin.
(14) Decouplers, for example binapacryl, dinocap, ferimzone, fluazinam and meptyldinocap.
(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulfate, diphenylamine, ecomat, fenpyrazamine, flumetover, fluoromide, flusulfamide, flutianil, fosetyl-aluminum, fosetyl-calcium, fosetyl-sodium, hexachlorobenzene, irumamycin, methasulfocarb, methyl isothiocyanate, metrafenon, mildiomycin, natamycin, nickel dimethyldithiocarbamate, nitrothal-isopropyl, octhilinone, oxamocarb, oxyfenthiin, pentachlorophenol and salts thereof, phenothrin, phosphoric acid and salts thereof, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrrolnitrin, tebufloquin, tecloftalam, tolnifanid, triazoxide, trichlamide, zarilamide, (3S,6S,7R,8R)-8-benzyl-3-[({3-[(isobutyryloxy)methoxy]-4-methoxy-pyridin-2-yl}carbonyl)amino]-6-methyl-4,9-dioxo-1,5-dioxonan-7-yl 2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoro-methyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoro-methyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoro-methyl)-1H-pyrazol-1-yl]ethanone, 1-(4-methoxyphenoxy)-3,3-dimethylbutan-2-yl 1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2,6-dimethyl-1H,5H-[1,4]dithiino[2,3-c:5,6-c′]dipyrrole-1,3,5,7 (2H,6H)-tetrone, 2-[5-methyl-3-(trifluoro-methyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts thereof, 3-(4,4,5-trifluoro-3,3-dimethyl-3,4-dihydroisoquinolin-1-yl)quinoline, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thia-diazole-2-thiol, 5-chloro-N′-phenyl-N′-(prop-2-yn-1-yl)thiophene-2-sulfonohydrazide, 5-fluoro-2-[(4-fluoro-benzyl)oxy]pyrimidine-4-amine, 5-fluoro-2-[(4-methyl-benzyl)oxy]pyrimidine-4-amine, 5-methyl-6-octyl-[1,2,4]triazolo[1,5-a]pyrimidine-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethyl-phenyl)-N-ethyl-N-methylimidoformamide, N-(4-chlorobenzyl)-3-[3-methoxy-4-(prop-2-yn-1-yloxy)phenyl]-propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodo-pyridine-3-carboxamide, N-{(E)-[(cyolopropylmethoxy)-imino][6-(difluoromethoxy)-2,3-difluorophenyl]methyl}-2-phenylacetamide, N-{(Z)-[(cyclopropylmethoxy)imino]-[6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylimidoformamide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoro-methyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoro-methyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]-amino}oxy)methyl]pyridin-2-yl}carbamate.
(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)-biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)-pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)-biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]-pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)-(2,3,4-trimethoxy-6-methylphenyl)methanone, N-[2-(4-{[3-(4-chlorophenyl)prop-2-yn-1-yl]oxy}-3-methoxy-phenyl)ethyl]-N2-(methylsulfonyl)valinamide, 4-oxo-4-[(2-phenylethyl)amino]butanoic acid and but-3-yn-1-yl {6-[({[(Z)-(1-methyl-1H-tetrazol-5-yl)(phenyl)-methylene]amino}oxy)methyl]pyridin-2-yl}carbamate.

Examples of bactericides include:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulfate and other copper preparations.

Examples of insecticides, acaricides and nematicides include:

(1) Acetylcholinesterase (AChE) inhibitors, such as carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, e.g. acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.
(2) GABA-gated chloride channel antagonists, for example cyclodiene-organochlorines, e.g. chlordane and endosulfan; or phenylpyrazoles (fiproles), e.g. ethiprole and fipronil.
(3) Sodium channel modulators/voltage-gated sodium channel blockers, for example pyrethroids, e.g. acrinathrin, allethrin, d-cis-trans allethrin, d-trans allethrin, bifenthrin, bioallethrin, bioallethrin S-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomers], deltamethrin, empenthrin [(EZ)-(1R) isomers], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans isomer], prallethrin, pyrethrins (pyrethrum), resmethrin, silafluofen, tefluthrin, tetramethrin, tetramethrin [(1R) isomers], tralomethrin and transfluthrin; or DDT; or methoxychlor.
(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam; or nicotine.
(5) Allosteric activators of the nicotinergic acetylcholine receptor (nAChR), for example spinosyns, e.g. spinetoram and spinosad.
(6) Chloride channel activators, for example avermectins/milbemycins, e.g. abamectin, emamectin benzoate, lepimectin and milbemectin.
(7) Juvenile hormone imitators, for example juvenile hormone analogs, e.g. hydroprene, kinoprene and methoprene; or fenoxycarb; or pyriproxyfen.
(8) Active ingredients with unknown or nonspecific mechanisms of action, for example alkyl halides, e.g. methyl bromide and other alkyl halides; or chloropicrin; or sulfuryl fluoride; or borax; or tartar emetic.
(9) Selective antifeedants, e.g. pymetrozine; or flonicamid.
(10) Mite growth inhibitors, e.g. clofentezine, hexythiazox and diflovidazin or etoxazole.
(11) Microbial disruptors of the insect gut membrane, e.g. Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.
(12) Oxidative phosphorylation inhibitors, ATP disruptors, for example diafenthiuron; or organotin compounds, e.g. azocyclotin, cyhexatin and fenbutatin oxide; or propargite; or tetradifon.
(13) Oxidative phosphorylation decouplers that interrupt the H proton gradient, for example chlorfenapyr, DNOC and sulfluramid.
(14) Nicotinergic acetylcholine receptor antagonists, for example bensultap, cartap hydrochloride, thiocyclam, and thiosultap-sodium.
(15) Chitin biosynthesis inhibitors, type 0, for example bistrifluron, chlorfluazuron, diflubenzuron, flucycloxuron, flufenoxuron, hexaflumuron, lufenuron, novaluron, noviflumuron, teflubenzuron and triflumuron.
(16) Chitin biosynthesis inhibitors, type 1, for example buprofezin.
(17) Molting disruptors, dipteran, for example cyromazine.
(18) Ecdysone receptor agonists, for example chromafenozide, halofenozide, methoxyfenozide and tebufenozide.
(19) Octopaminergic agonists, for example amitraz.
(20) Complex-III electron transport inhibitors, for example hydramethylnon; or acequinocyl; or fluacrypyrim.
(21) Complex-I electron transport inhibitors, for example METI acaricides, e.g. fenazaquin, fenpyroximate, pyrimidifen, pyridaben, tebufenpyrad and tolfenpyrad; or rotenone (Derris).
(22) Voltage-gated sodium channel blockers, for example indoxacarb; or metaflumizone.
(23) Inhibitors of acetyl-CoA carboxylase, for example tetronic and tetramic acid derivatives, e.g. spirodiclofen, spiromesifen and spirotetramat.
(24) Complex-IV electron transport inhibitors, for example phosphines, e.g. aluminum phosphide, calcium phosphide, phosphine and zinc phosphide; or cyanide.
(25) Complex-II electron transport inhibitors, for example cyenopyrafen.
(28) Ryanodine receptor effectors, for example diamides, e.g. chlorantraniliprole and flubendiamide.

Further active ingredients with an unknown mechanism of action, for example amidoflumet, azadirachtin, benclothiaz, benzoximate, bifenazate, bromopropylate, chinomethionat, cryolite, cyantraniliprole (Cyazypyr), cyflumetofen, dicofol, diflovidazin, fluensulfone, flufenerim, flufiprole, fluopyram, fufenozide, imidaclothiz, iprodione, pyridalyl, pyrifluquinazon and iodomethane; and additionally preparations based on Bacillus firmus (1-1582, BioNeem, Votivo).

Examples of herbicides include:

acetochlor, acibenzolar, acibenzolar-S-methyl, acifluorfen, acifluorfen-sodium, aclonifen, alachlor, allidochlor, alloxydim, alloxydim-sodium, ametryn, amicarbazone, amidochlor, amidosulfuron, aminocyclopyrachlor, aminocyclopyrachlor-potassium, aminocyclopyrachlor-methyl, aminopyralid, amitrole, ammonium sulfamate, ancymidol, anilofos, asulam, atrazine, aviglycine, azafenidin, azimsulfuron, aziprotryne, beflubutamid, benazolin, benazolin-ethyl, bencarbazone, benfluralin, benfuresate, bensulide, bensulfuron, bensulfuron-methyl, bentazone, benzfendizone, benzobicyclon, benzofenap, benzofluor, benzoylprop, benzyladenine, bicyclopyrone, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbaryl, carbetamide, carfentrazone, carfentrazone-ethyl, carvone, chlorocholine chloride, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, 4-chlorophenoxyacetic acid, chlorophthalim, chlorpropham, chlorthal-dimethyl, chlortoluron, chlorsulfuron, cinidon, cinidon-ethyl, cinmethylin, cinosulfuron, clethodim, clodinafop, clodinafop-propargyl, clofencet, clomazone, clomeprop, cloprop, clopyralid, cloransulam, cloransulam-methyl, cloxyfonac, cumyluron, cyanamide, cyanazine, cyclanilide, cycloate, cyclosulfamuron, cycloxydim, cycluron, cyhalofop, cyhalofop-butyl, cyperquat, cyprazine, cyprazole, cytokinine, 2,4-D, 2,4-DB, daimuron/dymron, dalapon, daminozide, dazomet, n-decanol, desmedipham, desmetryn, detosyl-pyrazolate (DTP), diallate, diaminozide, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenamid, diisopropylnaphthalene, dipropetryn, diquat, diquat-dibromide, dithiopyr, diuron, DNOC, eglinazine-ethyl, endothal, EPTC, esprocarb, ethalfluralin, ethametsulfuron, ethametsulfuron-methyl, ethyl naphthylacetate, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop, fenoxaprop-P, fenoxaprop-ethyl, fenoxaprop-P-ethyl, fenoxasulfone, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr, fluroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, glufosinate-ammonium, glufosinate-P, glufosinate-P-ammonium, glufosinate-P-sodium, glyphosate, glyphosate-isopropylammonium, H-9201, i.e. O-(2,4-dimethyl-6-nitrophenyl) O-ethyl isopropylphosphoramidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)-acetate, imazamethabenz, imazamethabenz-methyl, imazamox, imazamox-ammonium, imazapic, imazapyr, imazapyr-isopropylammonium, imazaquin, imazaquin-ammonium, imazethapyr, imazethapyr-ammonium, imazosulfuron, inabenfide, indanofan, indaziflam, indoleacetic acid (IAA), 4-indol-3-ylbutyric acid (IBA), iodosulfuron, iodosulfuron-methyl-sodium, iofensulfuron, iofensulfuron-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}-sulfonyl)-5,5-dimethyl-4,5-dihydro-1,2-oxazole, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazine-3-amine, MT-5950, i.e. N-[3-chloro-4-(1-methylethyl)phenyl]-2-methylpentanamide, NGGC-011, 1-naphthylacetic acid (NAA), naphthylacetamide (NAAm), 2-naphthoxyacetic acid, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitroguaiacolate, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-naphthyl}oxy)propanoate, sulcotrione, sulfallate (CDEC), sulfentrazone, sulfometuron, sulfometuron-methyl, sulfosate (glyphosate-trimesium), sulfosulfuron, SW-065, SYN-523, SYP-249, i.e. 1-ethoxy-3-methyl-1-oxobut-3-en-2-yl 5-[2-chloro-4-(trifluoro-methyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tembotrione, tepraloxydim, terbacil, terbucarb, terbuchlor, terbumeton, terbuthylazine, terbutryne, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triafamone, triallate, triasulfuron, triaziflam, triazofenamide, tribenuron, tribenuron-methyl, tribufos, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P and vernolate, ZJ-0862, i.e. 3,4-dichloro-N-{2-[(4,6-dimethoxypyrimidin-2-yl)oxy]-benzyl}aniline.

Examples of plant growth regulators also include natural plant hormones such as abscisic acid, jasmonic acid, salicylic acid and esters thereof, kinetin and brassinosteroids.

More preferably, the pesticides are cyclohexene oxime herbicides, glycine derivative herbicides, isoxazolidinone herbicides, phenoxyacetic acid herbicides, phenylpyrazoline herbicides, sulfonylurea herbicides, triketone herbicides, triazole fungicides, strobilurin fungicides, neonicotinoid insecticides, organophosphate insecticides, pyrethroid insecticides.

Especially preferably, the pesticides are tebuconazole, propiconazole, epoxiconazole, prothioconazole, cyproconazole, azoxystrobin, trifloxystrobin, imidacloprid, thiacloprid, chlorpyrifos, chlorpyrifos-methyl, isomeric cypermethrins, isomeric cyhalothrins, 2,4-D ester, clomazone, clethodim, nicosulfuron, iodosulfuron and mesosulfuron.

Particular preference is also given to the herbicide glyphosate, especially in combination with the preferred copolymer A) or the preferred compositions.

The one or more copolymers of component A) may fulfill a plurality of purposes in the pesticide compositions of the invention. Because of their chemical structure, they can act as emulsifier, wetting agent or dispersant in particular. The latter is of relevance for oil dispersions in particular.

The one or more copolymers of component A) and/or components of the liquid medium B) can also contribute to an increase in the biological efficacy of the pesticide, i.e. function as adjuvants. An adjuvant is understood to mean auxiliaries which increase the biological efficacy of the active ingredients without themselves exhibiting biological action, for example by improving the wetting, retention or absorption into the plant or the target organism.

The pesticide compositions used in accordance with the invention may optionally comprise further auxiliaries such as thickeners, dispersants, wetting agents, emulsifiers, preservatives, adjuvants, penetrants, cold stabilizers, colorants, defoamers and antioxidants.

Thickeners used may be any substances usable customarily for this purpose in agrochemical formulations, such as xanthan gum, cellulose, for example carboxy, methyl, ethyl or propyl cellulose, (optionally modified) bentonites, (optionally surface-modified) silicon dioxide.

Suitable additional solvents are any substances usable customarily for this purpose in agrochemical formulations, also including water-miscible solvents provided that they are anhydrous. Examples of further solvents are alkanes, alcohols, esters other than component B), ketones such as cyclohexanone, acetophenone, amides such as dimethyloctanamide, dimethyldecanamide and dimethyldodecanamide, dimethyllactamide, ethers, phosphoric esters such as tris(ethylhexyl) phosphate, phosphonic esters such as bis(ethylhexyl) ethylhexylphosphonate, pyrrolidones such as N-methyl- and N-ethylpyrrolidone, butyrolactone, esters of carbonic acid such as propylene carbonate, glycols or polyglycols.

Suitable wetting agents and dispersants are any substances usable customarily for this purpose in agrochemical formulations, such as nonionic, amphoteric, cationic and anionic (polymeric) surfactants.

Preferred dispersants and wetting agents are fatty alcohol ethoxylates, fatty alcohol alkoxylates, EO/PO block copolymers (EO: ethyleneoxy unit; PO: propyleneoxy unit), alkylarylsulfonic acids, alkylsulfonic acids, sulfonic acids of ethoxylated alcohols, sulfosuccinates, fatty acid methyl taurides, tristyrylphenol ethoxylates and alkoxylates, tri-sec-butylphenol ethoxylates, sulfated cresol-formaldehyde condensates, sulfated condensates of naphthalene and alkylnaphthalenes, lignosulfonates, phosphoric esters of ethoxylated fatty alcohols, tristyrylphenols and tri-sec-butylphenols, and also ether sulfates of ethoxylated fatty alcohols, tristyrylphenols and tri-sec-butylphenols, and polymeric dispersants.

Suitable emulsifiers are nonionic and anionic emulsifiers such as ethoxylates or alkoxylates of long-chain (C₈ to C₂₄) linear or branched alcohols, EO/PO block copolymers (EO: ethyleneoxy unit; PO: propyleneoxy unit), alkylphenol ethoxylates and alkoxylates or tristyrylphenol ethoxylates and alkoxylates, tri-sec-butylphenol ethoxylates, castor oil ethoxylates, esters of long-chain carboxylic acids with mono- or polyhydric alcohols and the ethoxylation products thereof, salts of dodecylbenzenesulfonic acid, sulfosuccinates, phosphoric esters of ethoxylated fatty alcohols, tristyrylphenols and tri-sec-butylphenols and salts thereof.

Preservatives used may be any substances usable customarily for this purpose in agrochemical formulations, such as organic acids and esters thereof, for example ascorbic acid, ascorbyl palmitate, sorbate, benzoic acid, methyl and propyl 4-hydroxybenzoate, propionates, phenol, for example 2-phenylphenate, 1,2-benzisothiazolin-3-one, formaldehyde.

Any further adjuvants used may be any substances usable customarily for this purpose in agrochemical formulations, such as alcohol alkoxylates, fatty amine ethoxylates, esters of phosphorous acid or of phosphoric acid such as bis(ethylhexyl) ethylhexylphosphonate or tris(ethylhexyl) phosphate, sorbitan ethoxylate derivatives and sorbitol ethoxylate derivatives.

Suitable penetrants are all substances which are typically used in order to improve the penetration of pesticides into plants or into target organisms: penetrants can be defined, for example, in that they can penetrate into the cuticle of the plant from the aqueous spray liquor and/or from a spray coating on the plant surface and hence increase the mobility of active ingredients in the cuticle. The method described in the literature can be used to determine this property (Baur et al., 1997, Pesticide Science 51, 131-152).

Usable substances which function as cold stabilizers may be any substances usable customarily for this purpose in agrochemical formulations. Examples include urea, glycerol and propylene glycol.

Suitable colorants are any substances usable customarily for this purpose in agrochemical formulations, such as oil-soluble dyes, and organic or inorganic pigments.

Suitable defoamers are any substances usable customarily for this purpose in agrochemical formulations, such as fatty acid alkyl ester alkoxylates; organopolysiloxanes such as polydimethylsiloxanes and mixtures thereof with microfine, optionally silanized silica; perfluoroalkyl phosphonates and phosphinates; paraffins; waxes and microcrystalline waxes, and mixtures thereof with silanized silica. Also advantageous are mixtures of various foam inhibitors, for example those of silicone oil, paraffin oil and/or waxes.

Useful antioxidants include any substances usable customarily for this purpose in agrochemical formulations, for example BHT (2,6-di-tert-butyl-4-methylphenol).

The proportion of the one or more copolymers of component A) in the pesticide compositions used in accordance with the invention is preferably 0.1% to 40% by weight, more preferably 0.5% to 30% by weight and especially preferably 1% to 20% by weight. These stated amounts are based on the total weight of the pesticide compositions of the invention.

In addition, the proportion of the one or more pesticides in the pesticide compositions used in accordance with the invention is preferably 0.1% to 75% by weight, more preferably 5% to 50% by weight and especially preferably 10% to 40% by weight. These stated amounts are based on the total weight of the pesticide compositions of the invention.

In pesticide compositions used in accordance with the invention which comprise the liquid medium B, the proportion of the one or more water-immiscible solvents of component B) is preferably 1% to 99.8% by weight, more preferably 5% to 80% by weight and especially preferably 10% to 70% by weight. These stated amounts are based on the total weight of the pesticide compositions of the invention.

The copolymers or compositions used in accordance with the invention can also be used for production of anhydrous compositions comprising one or more pesticides and likewise one or more surface-active substances. This results in compositions of the invention comprising one or more pesticides and one or more surface-active substances.

In a further preferred embodiment of the invention, the compositions or formulations used in accordance with the invention which comprise copolymers A) but no liquid medium B) therefore additionally comprise one or more pesticides and one or more surface-active substances. Such compositions of the invention are also referred to hereinafter as “pesticide compositions comprising surface-active substances used in accordance with the invention”.

In the pesticide compositions comprising surface-active substances used in accordance with the invention,
the proportion of the one or more copolymers of component A) is preferably 0.1% to 40% by weight, more preferably 0.5% to 30% by weight and especially preferably 1% to 20% by weight,
the proportion of the one or more pesticides is preferably 0.1% to 75% by weight, more preferably 5% to 50% by weight and especially preferably 10% to 40% by weight and
the proportion of the one or more surface-active substances is preferably 0.1% to 30% by weight, more preferably 0.5% to 25% by weight and especially preferably 1% to 20% by weight. These stated amounts are based on the total weight of the pesticide compositions of the invention comprising surface-active substances.

In pesticide compositions comprising surface-active substances used in accordance with the invention and comprising a liquid medium B), the proportion of the liquid medium of component B) is preferably 1% to 99.7% by weight, more preferably 5% to 80% by weight and especially preferably 10% to 70% by weight. These stated amounts are based on the total weight of the pesticide compositions used in accordance with the invention comprising surface-active substances.

The production of the pesticide compositions used in accordance with the invention, according to the formulation type, is possible by different routes which are sufficiently well known to those skilled in the art. It is also possible to produce the adjuvant compositions used in accordance with the invention by various routes which are sufficiently well known to those skilled in the art. The same applies to the production of the pesticide compositions comprising surface-active substances used in accordance with the invention and the production of aqueous emulsions from compositions of the invention.

In the use according to the invention, pesticide compositions are deployed in the form of spray liquors. This preferably involves producing a spray liquor by diluting a concentrate formulation, for example an emulsion concentrate used in accordance with the invention or an oil dispersion of the invention, with a defined amount of water.

The invention further provides a method of reducing drift in the application of pesticide formulations, wherein a preferably aqueous spray liquor is sprayed onto the plants to be treated or the site thereof, wherein the pesticide-containing spray liquor comprises one or more copolymers A) or a composition of the invention.

The invention likewise provides compositions for reducing drift in the application of pesticide formulations comprising one or more copolymers A) or a composition of the invention.

### EXAMPLES

The invention is illustrated hereinafter by examples, but these should not be regarded as any kind of restriction.

The commercial products used are:
Emulsogen® TS 200 tristyrylphenol ethoxylate (20 EO) from Clariant
Emulsogen® EP 4901 butanol-based EO/PO copolymer from Clariant
Emulsogen® 3510 butanol-based EO/PO copolymer from Clariant
Emulsogen® EL 360 ethoxylated castor oil (36 EO) from Clariant
Emulsogen® EL 400 ethoxylated castor oil (40 EO) from Clariant
Emulsogen® ELO modified castor oil ethoxylate from Clariant
Genapol® C 030 ethoxylated coconut fatty alcohol (3 EO) from Clariant
Marcol® 82 mineral oil from Exxon
Phenylsulfonat CA branched calcium dodecylbenzene-sulfonate in isobutanol from Clariant (70% strength by weight)
Phenylsulfonat CAL linear calcium dodecylbenzene-sulfonate in isobutanol from Clariant (70% strength by weight)
Solvesso® 200 ND aromatic hydrocarbon mixture from Exxon (solvent naphtha)
Solvesso® 150 aromatic hydrocarbon mixture from Exxon (solvent naphtha)
Synergen® KN fungicide adjuvant from Clariant (100% strength)

### Preparation Examples

### General Method for Preparation of Copolymers 1 to 7

The copolymers are prepared in two steps, with condensation of glycerol in the first step to give the corresponding polyglycerol which is then reacted with monocarboxylic acid and dicarboxylic acid to give the copolymer.

Preparation of polyglycerol (n=9.7): 2000 g of glycerol and 6.0 g of NaOH (50% by weight in water) were heated to 270° C. while stirring in a stirred apparatus with nitrogen inlet and water separator. After a reaction time of 9 hours and an output of 444 g of water, a sample was taken and the OH number was determined. The OH number found was 891 mg KOH/g. This corresponds to a mean condensation level n of 9.7 glycerol units.

Preparation of polyglycerol (n=5.0): 2000 g of glycerol and 6.0 g of NaOH (50% by weight in water) were heated to 270° C. while stirring in a stirred apparatus with nitrogen inlet and water separator. After a reaction time of 4 hours and an output of 226 g of water, a sample was taken and the OH number was determined. The OH number found was 1009 mg KOH/g. This corresponds to a mean condensation level n of 5.0 glycerol units.

The OH number is determined using the method described in DIN 53240.

Condensation of Polyglycerol with Mono- and Dicarboxylic Acid to Give the Copolymer:

The polyglycerol was introduced into a stirred vessel with a system for passage of N₂ and a water separator, and coconut fatty acid (C₈₁₁₈) and phthalic acid were added. Subsequently, the reaction mixture was heated to 220° C. while stirring until the copolymer has an acid number of <1.00 mg KOH/g (three to nine hours).

The acid number is determined using the method described in DIN EN ISO 2114.

Table 1 states the absolute amounts used for the monomers for preparation of copolymers 1-12 and the percentage by weight composition of copolymers 1-7 (for inventive compositions) and of copolymers 8-12 (for comparative compositions).

The percentage by weight compositions specified in table 1 for copolymers 1-12 are based on the total amount of the monomers as used for preparation of the copolymers. They do not relate to the final composition of the copolymers, which differs therefrom as a result of elimination of water released in the condensation.

TABLE 1
Composition of the copolymers

| | | | | | Propor- | Propor- | Propor- |
|---|---|---|---|---|---|---|---|
| | | | | | tion of | tion of | tion of |
| | | | | | glyc- | phthalic | coconut |
| | Glyc- | | Phthalic | Coconut | erol | acid | fatty acid |
| Copoly- | erol | | acid | fatty acid | [% by | [% by | [% by |
| mer | [g] | n | [g] | [g] | wt.] | wt.] | wt.] |
| 1 | 460 | 5.0 | 1.7 | 408 | 52.9 | 0.2 | 46.9 |
| 2 | 460 | 5.0 | 17 | 408 | 52.0 | 1.9 | 46.1 |
| 3 | 218 | 9.7 | 40.4 | 98.8 | 61.0 | 11.3 | 27.7 |
| 4 | 460 | 5.0 | 166 | 204 | 55.4 | 20.0 | 24.6 |
| 5 | 218 | 9.7 | 83 | 98.8 | 54.5 | 20.8 | 24.7 |
| 6 | 460 | 5.0 | 166 | 408 | 44.5 | 16.1 | 39.5 |
| 7 | 460 | 5.0 | 166 | 712 | 34.4 | 12.4 | 53.2 |

n: mean condensation level of the glycerol

Production of copolymer compositions used in accordance with the invention

### Example 1

600 g of copolymer 2 are introduced into 400 g of Solvesso® 200 ND while stirring. This gives a clear brown viscous solution.

### Example 2

600 g of copolymer 2 are introduced into 400 g of rapeseed oil methyl ester while stirring. This gives a clear brown viscous solution.

### Example 3

700 g of copolymer 2 are introduced into 300 g of Solvesso® 200 ND while stirring. This gives a clear brown viscous solution.

### Example 4

300 g of copolymer 2 are introduced into 700 g of Solvesso® 200 ND while stirring. This gives a clear brown viscous solution.

### Example 5

600 g of copolymer 5 are introduced into 400 g of rapeseed oil methyl ester while stirring. This gives a clear brown viscous solution.

### Example 6

600 g of copolymer 5 are introduced into 400 g of Solvesso® 200 ND while stirring. This gives a clear brown viscous solution.

### Example 7

600 g of copolymer 7 are introduced into 400 g of Solvesso® 200 ND while stirring. This gives a clear brown viscous solution.

### Example 8

600 g of copolymer 7 are introduced into 400 g of Solvesso® 200 ND while stirring. This gives a clear brown viscous solution.

### Examples of Pesticide Compositions

Pesticide compositions (emulsion concentrates) are produced from the components specified in each of the individual examples.

Pesticide composition 1: lambda-cyhalothrin-EC

50.0 g of lambda-cyhalothrin

### 30.0 g of Phenylsulfonat CAL

### 30.0 g of Emulsogen® EL 400

100.0 g of a 60% by weight solution of copolymer 5 in rapeseed oil methyl ester
695.0 g of rapeseed oil methyl ester

Pesticide composition 2: chlorpyrifos-EC

211.0 g of chlorpyrifos (97% by weight)

### 50.0 g of Phenylsulfonat CA

### 45.0 g of Emulsogen® EL 360

### 5.0 g of Emulsogen® 3510

80.0 g of a 60% by weight solution of copolymer 2 in Solvesso® 200 ND

### 609.0 g of Solvesso® 150

Pesticide composition 3: tebuconazole-EC

206.0 g of tebuconazole (97% by weight)

### 60.0 g of Emulsogen® EP 4901

### 40.0 g of Emulsogen® TS 200

50.0 g of a 60% by weight solution of copolymer 7 in Solvesso® 200 ND

### 150.0 g of Synergen KN

250.0 g of acetophenone
250.0 g of 2-ethylhexanol

Pesticide composition 4: 2,4-D isooctyl ester-EC

632.0 g of 2,4-D isooctyl ester (95% by weight)

### 17.0 g of Phenylsulfonat CA

### 24.0 g of Emulsogen® EL 360

50.0 g of a 60% by weight solution of copolymer 2 in Solvesso® 200 ND

### 277.0 g of Solvesso® 150

Pesticide composition 5: acetochlor-EC

262.0 g of acetochlor (94% by weight)
120.0 g of a 60% by weight solution of copolymer 7 in Solvesso® 200 ND

### 164.0 g of Solvesso® 150

Pesticide composition 6: adjuvant composition (crop oil concentrate)

A crop oil concentrate is produced from the followihg components:

### 138.0 g of Genapol® C 030

### 15.0 g of Phenylsulfonat CAL

200.0 g of a 60% by weight solution of copolymer 5 in Solvesso® 200 ND

### 647.0 g of Marcol® 82

The effect of the compositions used in accordance with the invention on the drift potential of an aqueous formulation can be assessed by determining the average droplet volumes of the spray mist and the distribution of the droplet sizes both under standard conditions and under the action of shear forces, and comparing the values determined for pure water, for example.

### Use examples

### Use example 1

### Effect of a Composition of Z1 Used in Accordance with the Invention on Droplet Size in the Case of Spray Application Compared to the Mowiol (Polyvinyl Alcohol) Standard

An inventive composition Z1 having a component A) obtained from glycerol, phthalic acid and coconut fatty acid and rapeseed oil methyl ester as component B), and also Mowiol as comparative substance, were sprayed onto corn leaves at the 2-3 leaf stage.

The spray application was conducted with an AI11002 air injector nozzle, hectare application rate 120 L/ha, at a spray velocity of about 3 km/h. A fluorescent dye was utilized as tracer in order to visualize the spray coverage under UV light.

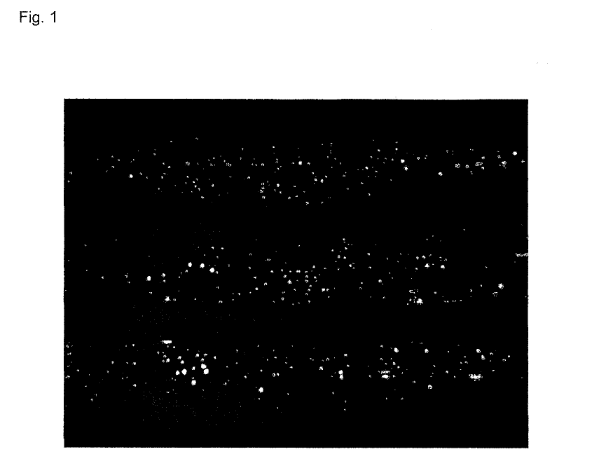

FIG. 1 shows, as a comparison, the positive standard for droplet adhesion on a leaf of poor wettability (corn, 2-3 leaf stage) with Mowiol 2688 (commercial product from Kuraray, block polymer) at spray concentration 1 g/L. 99% of the droplets are in the 10-68 pixel² class.

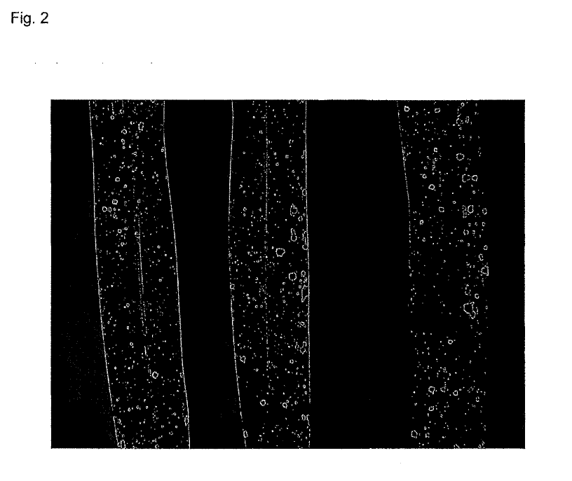

FIG. 2 shows Z1 at 1 g/L. It is noticeable here that the proportion of small droplets is lower than in the case of Mowiol (73% of the droplets in the 10-63 pixel² class).

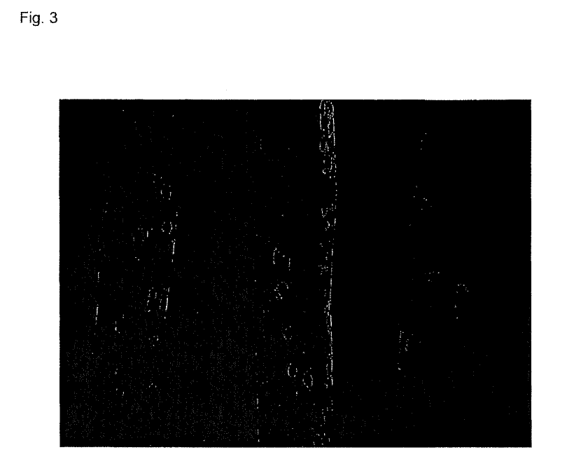

FIG. 3 shows the spray coverage with Z1, spray concentration 2.5 g/L. The droplets are much larger here; the proportion of small fine droplets—which are thus prone to drift—is reduced further (59% in the 10-63 pixel² class).

### Use examples 2-11

The inventive materials used were composition Z1 as an example 1, and the copolymer A) present therein alone (C1).

### Description of Methods

### Measurement of Droplet Size Distribution

A Malvern Spraytec real-time spray sizing system was used to determine the droplet size distribution. For this purpose, the system (STP5321, Malvern Instruments GmbH, Heidelberg, Germany) was installed in a specially constructed spray cabin, with the option of being able to choose spray applications customary in practice with a freely adjustable pressure for various hydraulic nozzles and freely adjustable distances (nozzle-target surface). The spray cabin can be darkened, and all disruptive parameters can be shut off. The nozzles used for the measurements were the standard flat-jet nozzles XR11002 (Teejet) and LU12002 (Lechler) with a fine droplet spectrum, and also the ID12002 injector nozzle (Lechler) with coarser droplet sizes. The pressure set was varied and a mean pressure of 3 bar was kept constant for the analyses reported hereinafter. The temperature and relative air humidity varied between 21.5° C. and 29° C. and between 33% and 56% respectively.

Therefore, water as a reference and the inventive Z1 at g/L in tap water were always analyzed as internal standards (usually before and after the analyses of the unknown samples). The Spraytec analysis was undertaken at the setting of 1 kHz, since analyses at 2.5 kHz or higher were found to be negligible, as were other influencing parameters such as additional suction. The analysis in the spray mist was kept constant at a position with distances of exactly 29.3 cm from the nozzle and 0.4 cm from the perpendicular beneath the nozzle. The analyses were effected within 5 seconds, and then the mean of 6 repetitions is reported as the proportion by volume of droplets having diameters <90 μm, <105 μm and 150 μm (percentage standard error 0.5%-2.5%). As a further analysis parameter, the proportion at 210 μm was determined and expressed in relation to the value for 105 μm, and the percentage change in the proportion by volume of fine droplets up to 105 μm was calculated in comparison with water.

Use example 2 Droplet size distribution for flat jet nozzle (at 3 bar), Z1 concentration series (compared to water)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 25.1 | 34.6 | 59.6 | 2.3 | XR11002 | — |
| Z1 | 0.5 | 14.2 | 21.3 | 43.7 | 3.2 | XR11002 | 38 |
| Z1 | 1.0 | 13.0 | 19.6 | 40.9 | 3.3 | XR11002 | 43 |
| Z1 | 2.0 | 13.4 | 20.2 | 42.4 | 3.3 | XR11002 | 42 |
| Z1 | 3.0 | 12.8 | 19.2 | 40.7 | 3.4 | XR11002 | 45 |
| Z1 | 4.0 | 12.6 | 18.9 | 40.2 | 3.4 | XR11002 | 45 |
| Z1 | 5.0 | 12.4 | 18.4 | 38.8 | 3.4 | XR11002 | 47 |
| Z1 | 10.0 | 13.2 | 19.4 | 40.2 | 3.3 | XR11002 | 44 |

Use example 3 Droplet size distribution for flat jet nozzle (at 3 bar), Z1 pure and formulations (compared to water)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 25.1 | 34.6 | 59.6 | 2.3 | XR11002 | — |
| Z1 | 5 | 12.4 | 18.4 | 38.8 | 3.4 | XR11002 | 47 |
| Z1 | 5 | 15.6 | 23.3 | 47.5 | 3.1 | XR11002 | 33 |
| EC | | | | | | | |
| XM6* | | | | | | | |
| Z1/isobutanol | 5 | 14.8 | 22.2 | 45.3 | 3.2 | XR11002 | 36 |
| 80/20 | | | | | | | |

*As emulsion concentrate XM6

Good reduction in the fine droplet content with droplet diameter below 105 μm by 33-36%, but smaller than with Z1 alone.

The ratio of the proportion of droplets at 210 μm and 105 μm was 3.1-3.4.

Use example 4 Droplet size distribution for flat jet nozzle (at 3 bar), C1 (copolymer A from Z1 alone) compared to water and Z1

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 26.7 | 36.8 | 62.8 | 2.3 | XR11002 | — |
| C1 | 1 | 15.7 | 23.0 | 45.5 | 3.0 | XR11002 | 37.5 |
| C1 | 2.5 | 15.6 | 23.1 | 46.0 | 3.0 | XR11002 | 37.2 |
| C1 | 5 | 18.3 | 26.7 | 51.2 | 2.8 | XR11002 | 27.4 |
| Z1 | 5 | 12.2 | 17.8 | 37.4 | 3.5 | XR11002 | 51.6 |

The water-soluble copolymer C1 alone already leads to a very good reduction in the fine droplet content with droplet diameter below 105 μm by up to 37.5% at only 1 g/L. This is only 6% less than the value for Z1 at 1 g/L (43%). At higher use concentrations of 5 g/L, Z1 with the oil component, in contrast, led to a much more significant reduction in the fine droplet content.

Use example 5 Droplet size distribution for flat jet nozzle—effects at different pressure of 3 and 5 bar, Z1 alone compared with water

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 26.7 | 36.9 | 63.1 | 2.3 | XR11002 | — |
| | | | | | | 3 bar | |
| Z1 | 5 g/L | 12.2 | 17.8 | 37.4 | 3.5 | XR11002 | 51.8 |
| | | | | | | 3 bar | |
| water | — | 34.4 | 45.0 | 69.7 | 1.9 | XR11002 | — |
| | | | | | | 5 bar | |
| Z1 | 5 g/L | 18.4 | 25.8 | 48.4 | 2.8 | XR11002 | 42.7 |
| | | | | | | 5 bar | |

Good reduction in the fine droplet content by Z1 with droplet diameter below 105 μm even at high pressure. Even at 5 bar, reduction by 43% compared to water.

Use example 6 Droplet size distribution with Z1 with different flat jet and injector nozzle compared to water (3 bar)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 24.3 | 33.6 | 58.2 | 2.3 | LU12002 | — |
| | | | | | | 3 bar | |
| Z1 | 5 g/L | 8.0 | 12.3 | 28.6 | 4.2 | LU12002 | 63.4 |
| | | | | | | 3 bar | |
| water | — | 1.9 | 3.0 | 7.9 | 5.3 | ID12002 | — |
| | | | | | | 3 bar | |
| Z1 | 5 g/L | 1.3 | 2.0 | 4.7 | 5.1 | ID12002 | 33.3 |
| | | | | | | 3 bar | |

Good reduction in the fine droplet content by Z1 with droplet diameter below 105 μm with other nozzles as well, including a very coarse-droplet injector nozzle. It should be emphasized that there was no further shift to greater droplet diameters in the case of the injector nozzle with larger droplets per se, but actually a desirable decrease in the proportion of large droplets.

Use example 7 Robust decrease in the fine droplets by Z1 in combination with a herbicide which increases the fine droplet content (injector nozzle, 3 bar)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 1.9 | 3.0 | 7.9 | 5.3 | ID12002 | — |
| | | | | | | 3 bar | |
| Round-Up | 15 | 5.7 | 8.9 | 20.1 | 4.0 | ID12002 | increase |
| Transsorb Z1 | | | | | | 3 bar | |
| | 5 | 1.3 | 2.0 | 4.7 | 5.1 | ID12002 | 33.3 |
| | | | | | | 3 bar | (vs. water) |
| Round-Up | 15 | 1.5 | 2.3 | 5.5 | 5.0 | ID12002 | 74 (vs. |
| Transsorb Z1 | 2.5 | | | | | 3 bar | RoundUp |
| | | | | | | | Transsorb) |
| Round-Up | 15 | 1.2 | 1.9 | 4.5 | 5.2 | ID12002 | 78 (vs. |
| Transsorb Z1 | 5 | | | | | 3 bar | RoundUp |
| | | | | | | | Transsorb) |

Excellent reduction in the fine droplet content by Z1 in combination with RoundUp Transsorb, an example of a herbicide formulation comprising the active ingredient glyphosate. This increased the fine droplet content by 200% based on water.

Z1, in contrast, lowers the fine droplet content in a concentration-dependent manner by more than 74% at economically viable use concentrations.

Use example 8 Reduction in the level of fine droplets through mixtures of Z1 with methylated seed oil (MSO) and ethylated seed oil (ESO) (injector nozzle, 3 bar)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 2.5 | 3.8 | 8.2 | 3.7 | ID12002 | — |
| | | | | | | 3 bar | |
| Z1/MSO | 5 | 1.5 | 2.1 | 3.9 | 3.3 | ID12002 | 44.7 |
| 75/25 | | | | | | 3 bar | |
| Z1/MSO | 5 | 1.3 | 1.8 | 3.5 | 3.9 | ID12002 | 52.6 |
| 50/50 | | | | | | 3 bar | |
| Z1/Bayol | 5 | 1.6 | 2.3 | 4.0 | 3.3 | ID12002 | 39.5 |
| 85 (with | | | | | | 3 bar | |
| 20% ELO*) | | | | | | | |
| 1/1 | | | | | | | |
| Z1/Edenor | 5 | 1.5 | 2.2 | 3.9 | 3.5 | ID12002 | 42.1 |
| TI 05** | | | | | | 3 bar | |
| (70/30) | | | | | | | |
| Z1/fatty acid | 5 | 1.7 | 2.4 | 4.5 | 3.8 | ID12002 | 36.8 |
| C8/10 | | | | | | 3 bar | |
| (70/30) | | | | | | | |
| Z1/castor oil | 5 | 1.6 | 2.3 | 4.1 | 3.5 | ID12002 | 39.5 |
| fatty acid | | | | | | 3 bar | |
| mixture | | | | | | | |
| (70/30) | | | | | | | |
| Z1/olive oil | 5 | 1.4 | 1.9 | 3.4 | 3.5 | ID12002 | 50 |
| fatty acid | | | | | | 3 bar | |
| mixture | | | | | | | |
| (70/30) | | | | | | | |

Very good reduction, with only low concentration dependence, in the fine droplet content having droplet diameter below 105 μm by 43%-53%. A 1/1 mixture of Z1 and MSO or Z1 and ESO showed the best result in each case.

Use example 9 Reduction in the level of fine droplets by mixtures of Z1 with white oil or fatty acids (injector nozzle, 3 bar)

* Addition of 10% or 20% Emulsogen ELO to the Bayol 85 (white oil) content for better emulsion, Z1/Bayol 85 ratio 1/1
** Edenor TI05 (tallow fat oleic acid)

Very good reduction in the fine droplet content in all cases, in the region of Z1 or Z1/MSO (75/25), with droplet diameter below 105 μm by 37%-50%. Z1 alone is exactly between the values.

Use example 10 Reduction in the fine droplet content of spray liquors comprising ammonium sulfate (AMS) with Z1 (injector nozzle, 3 bar)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 2.0 | 3.0 | 6.1 | 3.6 | ID12002 | |
| | | | | | | 3 bar | |
| Z1 | 5 | 1.5 | 2.2 | 3.9 | 3.2 | ID12002 | 26.7 |
| | | | | | | 3 bar | |
| RMS | 2.5 | 2.6 | 4.0 | 8.4 | 3.7 | ID12002 | increase |
| | | | | | | 3 bar | versus |
| | | | | | | | water 33.3 |
| AMS | 5 | 3.0 | 4.6 | 9.9 | 3.7 | ID12002 | increase |
| | | | | | | 3 bar | versus |
| | | | | | | | water 53.3 |
| AMS | 10 | 3.6 | 5.6 | 12.3 | 3.7 | ID12002 | increase |
| | | | | | | 3 bar | versus |
| | | | | | | | water 86.7 |
| AMS | 25 | 5.4 | 7.9 | 15.5 | 3.0 | | increase |
| | | | | | | | versus |
| | | | | | | | water 163.3 |
| Z1 + AMS | 5 | 1.5 | 2.1 | 3.7 | 3.3 | ID12002 | reduction |
| (in spray | 2.5 | | | | | 3 bar | versus |
| quality) | | | | | | | AMS 47.5 |
| Z1 + AMS | 5 | 1.6 | 2.3 | 4.1 | 3.4 | ID12002 | reduction |
| (in spray | 5 | | | | | 3 bar | versus |
| quality) | | | | | | | AMS 50 |
| Z1 + AMS | 5 | 1.8 | 2.4 | 4.4 | 3.7 | ID12002 | reduction |
| (in spray | 10 | | | | | 3 bar | versus |
| quality) | | | | | | | AMS 57.1 |
| Z1 + AMS) | 5 | 1.8 | 2.5 | 4.8 | 3.9 | ID12002 | reduction |
| (in spray | 25 | | | | | 3 bar | versus |
| quality | | | | | | | AMS 68.4 |

An excellent reduction in the fine droplet content with droplet diameter below 105 μm by 48%-68% is found for all AMS concentrations, even at 5 g/L of Z1. AMS alone, in contrast, greatly increased the fine droplet content.

Use example 11 Reduction in the fine droplet content of spray liquors comprising Z1 in the presence of a tallow amine ethoxylate surfactant which increases the fine droplet content (injector nozzle, 3 bar)

| | | | | | Vol. | | |
|---|---|---|---|---|---|---|---|
| | | | | | ratio | | % reduction in |
| Spray | Concentration | % V <90 | % V <105 | % V <150 | 210/105 | | fine droplet |
| liquid | [g/L] | μm rel. | μm rel. | μm rel. | μm | Nozzle | content <105 μm |
| water | — | 1.9 | 3.0 | 7.9 | 5.3 | XR11002 | |
| | | | | | | 3 bar | |
| Z1 | 5 | 1.3 | 2.0 | 4.7 | 5.1 | XR11002 | 33.3 |
| | | | | | | 3 bar | |
| Z1 + | 5 | 1.3 | 2.0 | 4.9 | 5.6 | XR11002 | 33.3 |
| tallow amine | 2 | | | | | 3 bar | |
| ethoxylate* | | | | | | | |

*Genamin T200 (commercial tallow amine ethoxylate)

Excellent reduction in the fine droplet content with droplet diameter below 105 μm by 33.3% even in the presence of a nonionic surfactant which increases the fine droplet content in the spray liquor by 10%-15%.

1. A method for reducing drift in an application of a pesticide formulation, comprising the step of adding one or more copolymers A), wherein the copolymers A) contain one or more structural units deriving from
a) 19.9% to 75.9% by weight of glycerol
b) 0.1% to 30% by weight of at least one dicarboxylic acid and
c) 24% to 80% by weight of at least one monocarboxylic acid of the formula (I)
R¹—COOH (I)
where R¹ is (C₅-C₂₉)-alkyl; (C₇-C₂₉)-alkenyl; phenyl or naphthyl, to the pesticide formulation.

2. A method for reducing drift in an application of a pesticide formulation, as claimed in claim 1 comprising the step of adding a composition comprising
A) one or more copolymers, wherein the copolymers contain one or more structural units deriving from
a) 19.9% to 75.9% by weight of glycerol
b) 0.1% to 30% by weight of at least one dicarboxylic acid and
c) 24% to 80% by weight of at least one monocarboxylic acid of the formula (I)
R¹—COOH (I)
where R¹ is (C₅-C₂₉)-alkyl; (C₇-C₂₉)-alkenyl; phenyl or naphthyl
and
B) a water-immiscible liquid medium comprising one or more representatives from the group consisting of esters of mono- and dicarboxylic acids, the acid and/or alcohol component of the latter having at least 4 carbon atoms, vegetable oils, mineral oils and aromatic hydrocarbons,
to the pesticide formulation.

3. The method as claimed in claim 2, wherein the compositions contains water in an amount less than or equal to 1.0% by weight, based on the total weight of the composition.

4. The method as claimed in claim 1, wherein the at least one dicarboxylic acid b) is oxalic acid; a dicarboxylic acid of the formula (II)
HOOC—R²—COOH (II)
and/or a dicarboxylic acid of the formula (III) 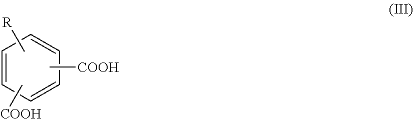
where R² is a (C₁-C₄₀)-alkylene bridge or a (C₂-C₂₀)-alkenylene bridge and R is H, (C₁-C₂₀)-alkyl, (C₂-C₂₀)-alkenyl, phenyl, benzyl, halogen, —NO₂, (C₁-C₆)-alkoxy, —CHO or —CO((C₁-C₅)-alkyl).

5. The method as claimed in claim 1, wherein the at least one dicarboxylic acid b) is phthalic acid and the at least one monocarboxylic acid c) is coconut fatty acid.

6. The method as claimed in claim 2, wherein the water-immiscible liquid medium comprises C₆-C₁₆ aromatics mixtures methyl esters of fatty acids of vegetable or animal origin.

7. The method as claimed in claim 2, wherein the proportion of the one or more copolymers of component A) in the composition is 1% to 90% by weight, and the proportion of component B) is 10% to 99% by weight.

8. The method as claimed in claim 1, wherein the pesticide formulation additionally comprises one or more pesticides.

9. The method as claimed in claim 8, wherein the proportion of the one or more copolymers A) is 0.1% to 40% by weight, and the proportion of the one or more pesticides is 0.1% to 75% by weight.

10. The method as claimed in claim 9, wherein the proportion of component B) is 1% to 99.8% by weight.

11. The method as claimed in claim 2, wherein the composition additionally comprises one or more surface-active substances.

12. The method as claimed in claim 11, wherein the proportion of the one or more copolymers A) is 1% to 90% by weight, and the proportion of the one or more surface-active substances is 0.1% to 50% by weight.

13. The method as claimed in claim 12, wherein the proportion of the one or more water-immiscible solvents in component B) is 1% to 98.9% by weight.

14. The method as claimed in claim 2, wherein the composition additionally comprises one or more pesticides and one or more surface-active substances.

15. The method as claimed in claim 14, wherein the proportion of the one or more copolymers A) is 0.1% to 40% by weight, the proportion of the one or more pesticides is 0.1% to 75% by weight, and the proportion of the one or more surface-active substances is 0.1% to 30% by weight.

16. The method as claimed in claim 14, wherein the proportion of component B) is 1% to 99.7% by weight.

17. A method of reducing drift in the application of pesticide formulations, wherein a spray liquor is sprayed onto the plants to be treated or the site thereof, wherein the pesticide-containing spray liquor comprises one or more copolymers A) claim 1.

18. The method as claimed in claim 2, wherein the composition additionally comprises one or more pesticides.

19. The method as claimed in claim 18, wherein the proportion of the one or more copolymers A) is 0.1% to 40% by weight, and the proportion of the one or more pesticides is 0.1% to 75% by weight.

20. The method as claimed in claim 19, wherein the proportion of component B) is 1% to 99.8% by weight.
